(19) United States
(12) Patent Application Publication
(10) Pub. No.: US 2019/0325898 A1
(43) Pub. Date: Oct. 24, 2019

(54) ADAPTIVE END-OF-UTTERANCE TIMEOUT FOR REAL-TIME SPEECH RECOGNITION

(71) Applicant: SoundHound, Inc., Santa Clara, CA (US)

(72) Inventors: Liam O'Hart Kinney, San Francisco, CA (US); Joel McKenzie, San Francisco, CA (US); Anitha Kandasamy, Sunnyvale, CA (US)

(73) Assignee: SoundHound, Inc., Santa Clara, CA (US)

(21) Appl. No.: 15/959,590

(22) Filed: Apr. 23, 2018

(51) Int. Cl. G10L 25/78; G10L 15/197; G10L 15/06; G10L 15/18; G10L 15/02

(52) U.S. Cl. CPC G10L 25/78; G10L 15/197; G10L 2015/025; G10L 15/1807; G10L 15/02; G10L 15/063

(57) ABSTRACT

Real-time speech recognition systems extend an end-of-utterance timeout period in response to the presence of a disfluency at the end of speech, and by so doing avoid cutting off speakers mid-sentence. Approaches to detecting disfluencies include the application of disfluency n-gram language models, acoustic models, prosody models, and phrase spotting. Explicit pause phrases can also be detected to extend sentence parsing until relevant semantic information is gathered from the speaker or another voice. Disfluency models can be trained such as by searching by successive deletion of tokens, phonemes, or acoustic segments to convert sentences that cannot be parsed into ones that can. Disfluency-based timeout adaptation is applicable to safety-critical systems.

### FIELD OF THE INVENTION

The present invention is in the field of real-time speech recognition systems, such as ones integrated with virtual assistants and other systems with speech-based user interfaces.

### BACKGROUND

Systems that respond to spoken commands and queries, to be most useful, respond as quickly as possible after a user finishes a complete sentence. However, if, before the user has finished speaking their intended complete sentence, the system incorrectly hypothesizes that the sentence is complete and responds based on an incomplete sentence, the user is likely to be very frustrated with the experience.

In communication between humans, speakers often use disfluencies to signal to listeners that their intended sentence is not complete. Therefore, what is needed is a system and method that can determine when disfluencies occur and adapt the duration of an end-of-utterance timeout.

### SUMMARY OF THE INVENTION

Whereas conventional systems set an end-of-utterance (EOU) timeout over which, without detectable speech, the system hypothesizes an EOU condition and proceeds to act on the sentence, some embodiments of the present invention dynamically adapt the EOU timeout in response to a detection of certain disfluencies.

Some embodiments lengthen the EOU timeout in response to certain disfluencies. Some embodiments shorten the EOU timeout in response to certain words or sounds such as “alright?” or the Canadian “ehh?”. The following discussion describes lengthening the EOU timeout in response to disfluencies, but some embodiments distinguish between lengthening disfluencies and shortening disfluencies and adapt the EOU timeout accordingly.

Some embodiments include disfluencies as specially tagged n-grams within a statistical language model. Accordingly, traditional speech recognition can detect the disfluencies. Such embodiments adapt their EOU timeout according to whether the most recently recognized n-gram is one tagged as a disfluency or not.

Some embodiments enhance the accuracy of disfluency score calculations by detecting prosodic features and applying a prosodic feature model to weight the disfluency score.

Some embodiments enhance the accuracy of disfluency score calculations by detecting acoustic features and applying an acoustic feature model to weight the disfluency score.

Some embodiments enhance the accuracy of disfluency score calculations by recognizing a transcription, parsing the transcription according to a grammar, and weighting the disfluency score by whether, or how well, the grammar parses the transcription.

Scores, generally represent probabilities that something is true. Some embodiments compute scores as integers or floating-point values and some embodiments use Boolean values.

Some embodiments use a phrase spotter trained for spotting disfluencies.

Some embodiments detect key phrases in speech that indicate a request to pause parsing of a sentence, then proceed to recognize speech until detecting semantic information that is applicable to the sentence as parsed so far, then continue parsing using the semantic information.

Some embodiments learn disfluencies such as by training an acoustic model, prosodic model, or statistical language model. Some embodiments learn by a method of parsing of transcriptions with deleted tokens.

Some embodiments are methods, some are network-connected server-based systems, some are stand-alone devices such as vending machines, some are mobile devices such as automobiles or automobile control modules, some embodiments are safety-critical machines controlled by disfluent speech, and some are non-transitory computer readable media storing software. Ordinarily skilled practitioners will recognize many equivalents to components described in this specification.

### BRIEF DESCRIPTION OF THE DRAWINGS

FIG. 1 shows a timeline of adapting an EOU timeout for the beginning of an English sentence according to an embodiment.

FIG. 2 shows a timeline of adapting an EOU timeout for the beginning of a Mandarin Chinese sentence according to an embodiment.

FIG. 3 shows a speech recognition system with means for detecting disfluencies and means for signaling an EOU according to an embodiment.

FIG. 4 shows a flowchart for signaling an EOU according to an embodiment.

FIG. 5 shows a flowchart for adapting an EOU timeout based on acoustic features according to an embodiment.

FIG. 6 shows a flowchart for adapting an EOU timeout based on prosodic features according to an embodiment.

FIG. 7 shows a flowchart for computing a disfluency score according to an embodiment.

FIG. 8 shows a flowchart for adapting an EOU timeout based on whether a transcription can be parsed according to an embodiment.

FIG. 9 shows adapting an EOU timeout based on an acoustic disfluency model, phonetic disfluency model, and transcription disfluency model according to an embodiment.

FIG. 10A shows an automobile with speech recognition having an adaptive EOU timeout according to an embodiment.

FIG. 10B shows components of an automobile with speech recognition having an adaptive EOU timeout according to an embodiment.

FIG. 11A shows a rotating disk non-transitory computer readable medium according to an embodiment.

FIG. 11B shows Flash RAM chip non-transitory computer readable medium according to an embodiment.

FIG. 12A shows a packaged system-on-chip according to an embodiment.

FIG. 12B shows a block diagram of a system-on-chip according to an embodiment.

FIG. 13A shows a rack-based server according to an embodiment.

FIG. 13B shows a block diagram of a server according to an embodiment.

FIG. 14 shows a chart of Carnegie Mellon University standard phoneme codes.

### DETAILED DESCRIPTION

The following describes various embodiments of the present invention that illustrate various interesting aspects. Generally, embodiments can use the described aspects in any combination.

Some real-time speech recognition systems ignore disfluencies. They consider constant sounds, even if they seem like a human voice, to be non-speech and simply start the EOU timeout when they hypothesize non-speech, regardless of whether or not there seems to be voice activity. This has the benefit of being very responsive, even in the presence of background hum. However, people rarely end sentences with “umm”. Detecting that is useful information for making a real-time decision about whether a sentence has ended.

Some real-time speech recognition systems use voice activity detection to determine when to start an EOU timeout. As long as captured sound includes spectral components that seem to indicate the presence of a human voice, such systems assume voice activity and do not start the EOU timeout. This can be useful to avoid cutting off speakers who use disfluencies to indicate that they are not finished speaking. However, this can cause the system to continue indefinitely without responding if there are certain kinds of background hum. Some systems overcome that problem by, rather than not starting the timeout, starting it and extending it if there is sound that sounds like a human voice. However, this compromise has somewhat of the disadvantages of each approach.

Some embodiments recognize non-word sounds as disfluencies such as, in English, “uhh” and “umm”, in Mandarin, “ [symbol] ”, in Japanese, “ [symbol] ” and “ [symbol] ”, and in Korean “ [symbol] ”, “ [symbol] ”, and “ [symbol] ”. Some embodiments recognize dictionary words or sequences of words as disfluencies such as, in English, “you know”, and “like”, and in Mandarin, “ [symbol] ”, “ [symbol] ”.

### Adapting EOU for Disfluencies

Many speech recognition and natural language understanding systems have multiple stages, such as acoustic-phonetic processing, prosody detection, linguistic processing, and grammar parsing, each of which can exhibit features that indicate likely disfluencies. The features calculated for any one or any combination of stages can be used to compute or adapt a real-time dynamic value indicating a hypothesis of whether a disfluency is present or not.

Consider the example “I want a red uhh . . . green and like - - - blue candy”. At a first disfluency, the speaker makes the sound “uhh”, which is not a dictionary word but indicates the disfluency. At a second disfluency, the speaker says the word, “like”, followed by silence. The word “like” is a dictionary word but is not grammatically meaningful. It also indicates a disfluency.

Consider the example “ [symbol] [symbol] [symbol] [symbol] [symbol] ”. At a first disfluency, the speaker makes the sound “ [symbol] ”, which is not a dictionary word but indicates the disfluency. At a second disfluency, the speaker says the word, “ [symbol] ”, followed by silence. The word “ [symbol] ” is a dictionary word but is not grammatically meaningful. It also indicates a disfluency.

Some embodiments, rather than ignoring “uhh” “ [symbol] ” sounds or cutting them off or cutting off periods of no voice activity after “like” or “ [symbol] ”, instead use these as cues to extend the EOU timeout. This has a benefit of allowing the system user time to think about what they want to say without affecting transcription or causing them to hurry.

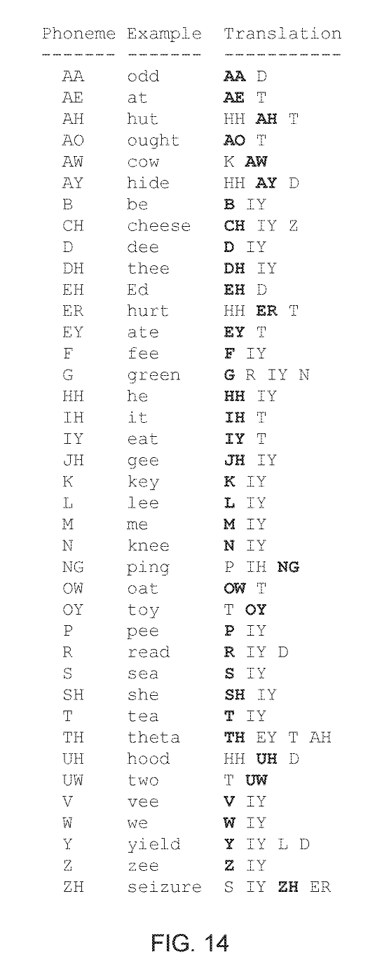

FIG. 14 shows a reference table of the Carnegie Mellon University (CMU) codes representing common English phonemes. The codes are widely used in the field of English speech recognition. The following specification uses the CMU phoneme codes for English and as approximate representations of phonemes in other languages.

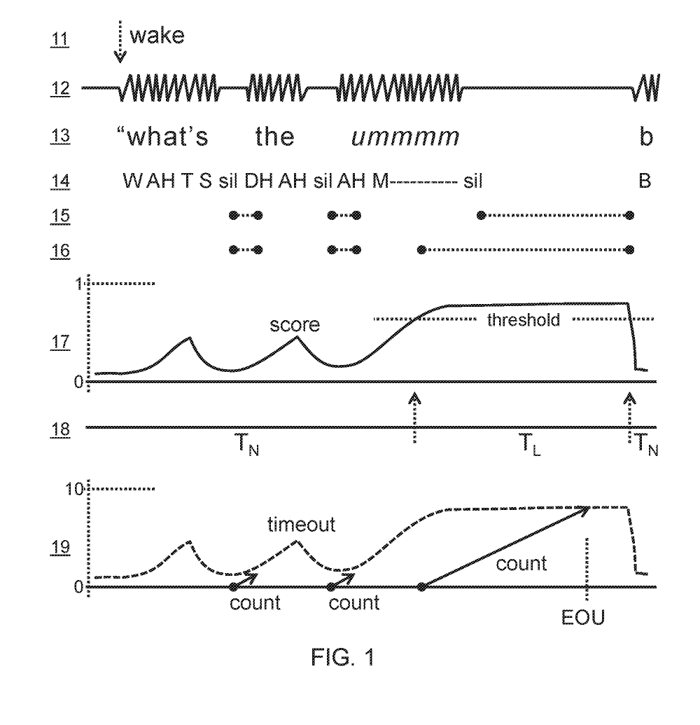

FIG. 1 shows a timeline diagram of adapting an EOU timeout in response to a disfluency within a partial sentence. Row 11 shows the wake-up time that begins the processing of a sentence. Row 12 shows a waveform of captured speech audio. Row 13 shows the words spoken at the beginning of the sentence corresponding to the waveform. The words are “what's the ummmm b . . . ”. Row 14 shows the CMU phoneme codes for the phoneme with the highest score by a speech phoneme recognizer algorithm. This includes a silence phoneme.

Row 15 shows, for one embodiment, the time ranges during which the system detects no voice activity and therefore begins the timing sequence towards detecting an EOU. In accordance with some embodiments, the system considers silence to be the indicator of voice inactivity.

Row 16 shows, for another embodiment, the time ranges during which the system detects no voice activity and therefore begins the timing sequence towards detecting an EOU. In accordance with some embodiments, the system considers silence and long periods of extension of a single phoneme feature as indicators of voice inactivity. This is apparent from the fact that a period of no voice activity begins during the extended M phoneme period.

Row 17 shows a graph of a disfluency score as the system adapts it over time. A rising value corresponds to the AH phonemes in “what's” and “the” because AH begins the disfluency “ummmm”. When the disfluency “ummmm” occurs, the disfluency score continues to increase beyond a threshold value. Some embodiments use a threshold or more than one threshold to determine whether a disfluency is present or not in order to switch between two or more EOU timeouts. Some embodiments do not use a threshold and compute an EOU timeout as a function of the score.

Row 18 shows, for an embodiment that uses a single threshold, periods of using a normal timeout (T_{N}), periods of using a long timeout (TO, and points of switching between the timeout values.

Row 19 shows (for an embodiment that considers extended phoneme periods to be periods of no voice activity and for which there is no threshold and simply a direct mapping of disfluency score to EOU timeout) the periods of time counting towards an EOU and linear count values as diagonal-pointing arrows. During the first two periods of time counting, the count value arrow never reaches the dynamically changing score, so no EOU event occurs. The third time the count increases, it eventually reaches the score level, at which time the system determines that it has detected an EOU.

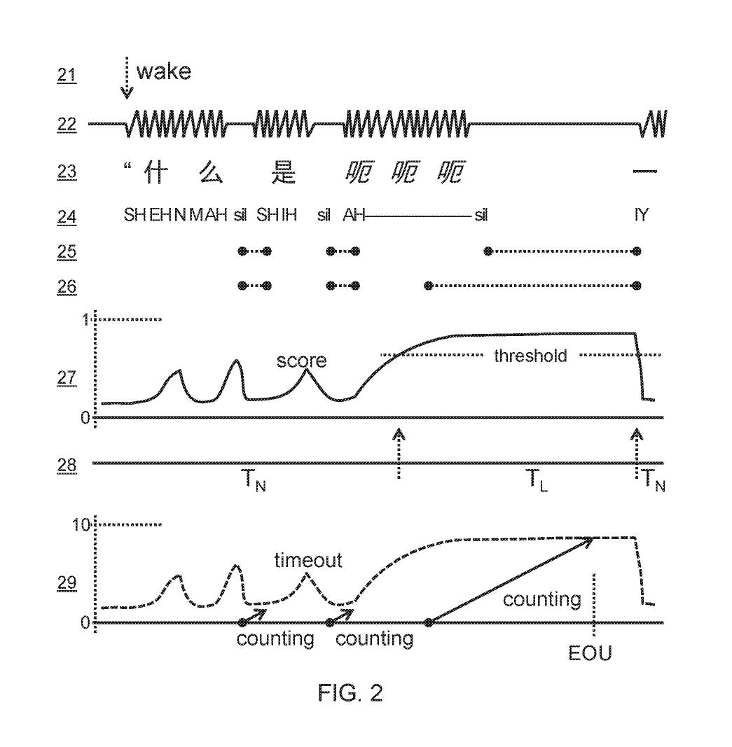

FIG. 2 shows a timeline diagram of adapting an EOU timeout in response to a disfluency within a partial sentence. Row 21 shows the wake-up time that begins the processing of a sentence. Row 22 shows a waveform of captured speech audio. Row 23 shows the words spoken at the beginning of the sentence corresponding to the waveform. The words are “ [symbol] ”. Row 23 shows the CMU phoneme code approximations for the phoneme with the highest score by a speech phoneme recognizer algorithm. This includes a silence phoneme.

Row 25 shows, for one embodiment, the time ranges during which the system detects no voice activity and therefore begins the timing sequence towards detecting an EOU. In accordance with some embodiments, the system considers silence to be the indicator of voice inactivity.

Row 26 shows, for another embodiment, the time ranges during which the system detects no voice activity and therefore begins the timing sequence towards detecting an EOU. In accordance with some embodiments, the system considers silence and lengthy periods of extension of a single phoneme feature as indicators of voice inactivity. This is apparent from the fact that a period of no voice activity begins during the extended M phoneme period.

Row 27 shows a graph of a disfluency score as the system adapts it over time. A rising value corresponds to the EH phoneme in “ [symbol] ”, the AH phoneme in “ [symbol] ” and the IH phoneme in “ [symbol] ” because those phonemes are close to the AH phoneme of the disfluency “ [symbol] ”. When the disfluency “ [symbol] ” occurs, the disfluency score continues to increase beyond a threshold value. Some embodiments use a threshold or more than one threshold to determine whether a disfluency is present or not in order to switch between two or more EOU timeouts. Some embodiments do not use a threshold and compute an EOU timeout as a function of the score.

Row 28 shows, for an embodiment that uses a single threshold, periods of using a normal timeout (T_{N}), periods of using a long timeout (T_{L}), and points of switching between the timeout values.

Row 29 shows (for an embodiment that considers extended phoneme periods to be periods of no voice activity and for which there is no threshold and simply a direct mapping of disfluency score to EOU timeout) the periods of time counting towards an EOU and linear count values as diagonal-pointing arrows. During the first two periods of time counting, the count value arrow never reaches the dynamically changing score, so no EOU event occurs. The third time the count increases, it eventually reaches the score level, at which time the system determines that it has detected an EOU.

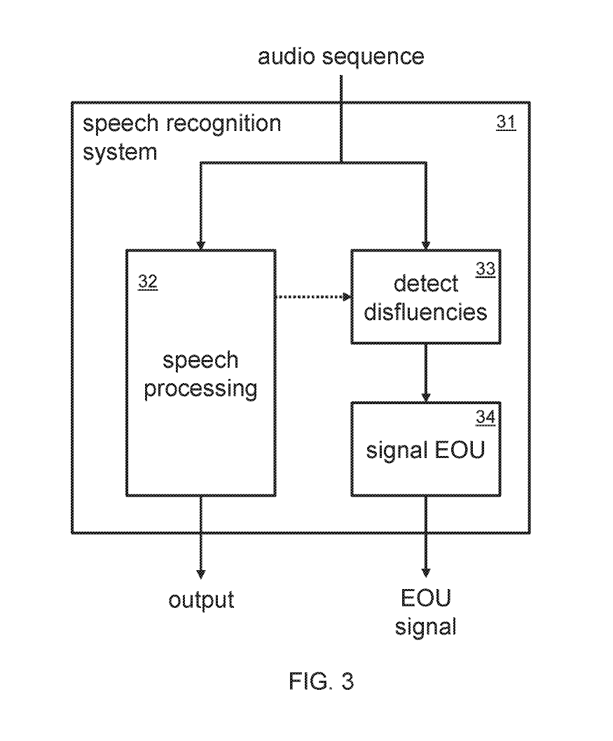

FIG. 3 shows a diagram of a speech recognition system 31 having means for ordinary speech processing 32, means for detecting disfluencies 33, and means for signaling an EOU 34. The speech recognition system 31 receives an audio sequence. Speech processing means 32 processes the audio sequence and produces a speech recognition output. Any appropriate speech processing method is fine. Means for detecting disfluencies 33 also takes the audio sequence as input, detects disfluencies, and produces an output indicating so. In some embodiments, the output is a Boolean value indicating whether a disfluency is currently present in the speech. In some embodiments, the output of the means for detecting disfluencies is a score or other numerical or analog representation. The means to signal an EOU 34 takes the output of the means for detecting disfluencies and produces an output of the speech recognition system that is an EOU signal. A speech interface system that incorporates speech recognition system 31 can use the EOU signal for purposes such as determining when to cut off receiving an audio sequence or when to compute a response.

Various structures are possible for implementing the means for detecting disfluencies 33. Some embodiments use hardwired logic, such as in an ASIC and some embodiments use reconfigurable logic such as in FPGAs. Some embodiments use specialized ultra-low-power digital signal processors optimized for always-on audio processing in system-on-chip devices. Some embodiments, particularly ones in safety-critical systems, use software-based processors with redundant datapath logic and error detection mechanisms to identify computation errors in detection.

Some embodiments use intermediate data values from speech processing 32 as inputs to the means for detecting disfluencies 33. Some examples of useful data values are voice formant frequency variation, phoneme calculations, phoneme sequence or n-gram-segmented word sequence hypotheses, and grammar parse hypotheses.

Various structures are possible for implementing the means for signaling EOU 34. These include the same types of structures as the means for detecting disfluencies 33. Some embodiments of means for signaling EOU 34 output a value stored in temporary memory for each frame of audio, each distinctly recognized phoneme, or each recognized n-gram. Some embodiments store a state bit that a CPU processing thread can poll on a recurring basis. Some embodiments toggle an interrupt signal that triggers an interrupt service routine within a processor.

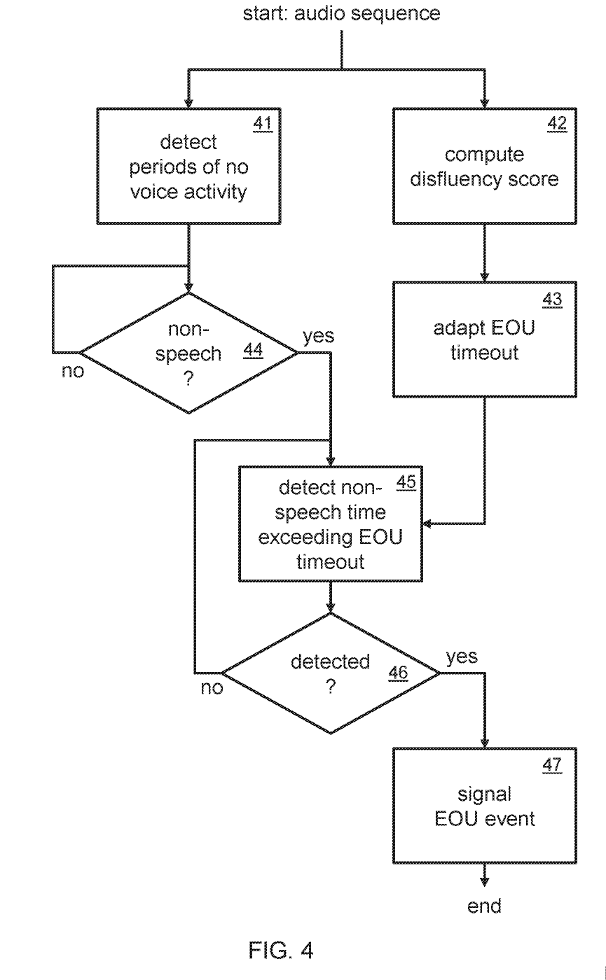

FIG. 4 shows a process for determining when to signal an EOU based, in part, on adapting an EOU timeout. The process starts with an audio sequence. A step 41 uses the audio sequence, in real-time, to detect periods of voice activity and no voice activity in the audio sequence. A step 42 uses the audio sequence, in real time, to compute a disfluency score according to an appropriate approach. A step 43 adapts the EOU timeout as a function of the disfluency score. Doing so enables the process to prevent an improper timeout that disrupts receiving a complete sentence in the audio sequence.

A decision 44 calls, during periods of no voice activity, a step 45 that detects when the non-speech period has exceeded the adapted EOU timeout. A decision 46, when a non-speech period has exceeded a timeout, calls for a step 47 to signal an EOU event.

Some embodiments signal the EOU event precisely when a period of no voice activity reaches a timeout.

Some embodiments provide the system user a signal predicting an upcoming timeout. Some embodiments use a visual indication, such as a colored light or moving needle. Some embodiments use a Boolean (on/off) indicator of an impending timeout. Some embodiments use an indicator of changing intensity.

Some embodiments use an audible indicator such as a musical tone, a hum of increasing loudness, or a spoken word. This is useful for embodiments with no screen. Some embodiments use a tactile indicator such as a vibrator. This is useful for wearable or handheld devices. Some embodiments use a neural stimulation indicator. This is useful for neural-machine interface devices.

Some embodiments that provide indications of upcoming EOU events do so according to the strength of the disfluency score. Some embodiments that provide indications of upcoming EOU events do so according to the timeout value.

Different approaches, either alone or in combination, are useful for computing disfluency scores.

### Acoustic Feature Approach

Various speech recognition systems use acoustic models, such as hidden Markov models (HMM) and recurrent neural networks (RNN) acoustic models to recognize phonemes from speech audio. The same types of models useful for recognizing speech phonemes are generally also useful to compute disfluency scores.

Some examples of acoustic features that can indicate disfluencies are unusually quick decreases and increases in volume or upward inflection.

The stereotypical Canadian disfluency “ehhh” with a rising tone (Mandarin 4th tone) at the ends of sentences, for example, is an easily recognizable acoustic feature. However, it tends to indicate a higher probability of sentence completion rather than a typical disfluency to stall for time.

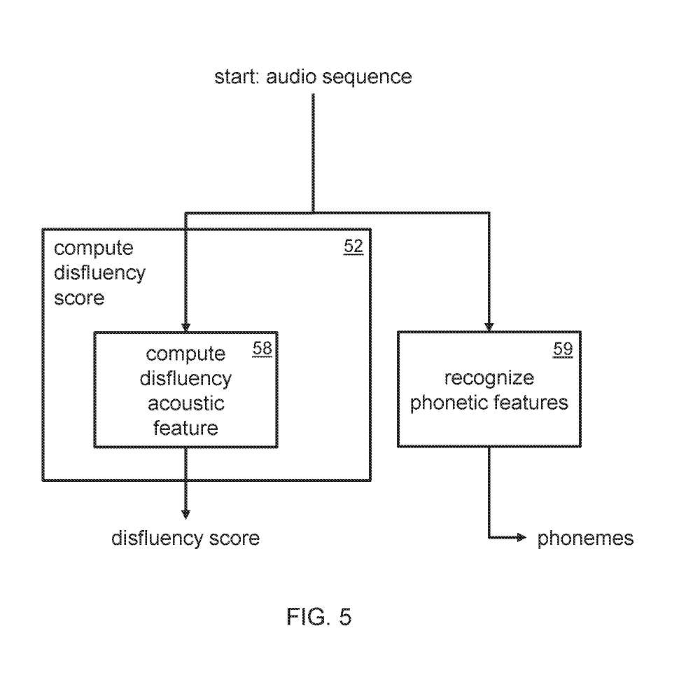

FIG. 5 shows an embodiment that uses acoustic disfluency features to compute a disfluency score. The process step 52 of computing a disfluency score comprises a step 58 of computing an acoustic disfluency feature, the value of which provides the disfluency score directly. Some embodiments include other functions, such as scaling or conditioning, between the computation of the acoustic disfluency feature and the production of the disfluency score.

In the embodiment of FIG. 5, a parallel step 59 of acoustic feature computation is used to recognize phonemes for speech recognition. In some embodiments, steps 58 and 59 are one, and phonemes, as well as a disfluency feature value, come out of the computation.

### Prosodic Feature Approach

Various speech recognition systems use prosody models to recognize prosody from speech audio. Prosody is useful in some systems for various purposes such as to weight statistical language models, to condition natural language parsing, or to determine speaker mood or emotion. The same types of models useful for recognizing speech prosody are generally also useful to compute disfluency scores.

Some examples of prosody features that can indicate disfluencies are decreases in speech speed and increase in word emphasis.

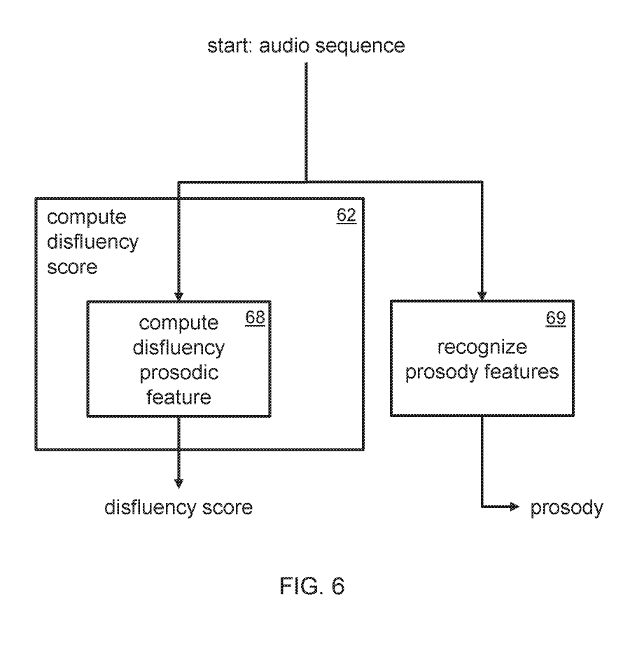

FIG. 6 shows an embodiment that uses prosodic disfluency features to compute a disfluency score. The process step 62 of computing a disfluency score comprises a step 68 of computing a disfluency prosodic feature, the value of which provides the disfluency score directly. Some embodiments include other functions, such as scaling or conditioning, between the computation of the acoustic disfluency feature and the production of the disfluency score.

In the embodiment of FIG. 6, a parallel step 69 of prosodic feature computation is used to recognize prosody in recognized speech. In some embodiments, steps 68 and 69 are one, and prosody, as well as a disfluency feature value, come out of the computation.

### Language Modeling Approach

Some embodiments use n-gram SLMs to recognize sequences of tokens in transcriptions. Tokens can be, for example, English words or Chinese characters and meaningful character combinations. Some embodiments apply a language model with disfluency disfluency-grams to the transcription to detect disfluencies.

Some embodiments include, within a pronunciation dictionary, non-word disfluencies such as “AH M” or “AH” (as a homophone for the word “a”), with the words tagged as disfluencies. Some embodiments include tokens such as “like” and “you know” and “ [symbol] ” within n-gram statistical language models (SLMs). Such included words are tagged as disfluencies, and the SLMs are trained with the disfluencies distinctly from the homophone tokens that are not disfluencies.

Some embodiments with SLMs trained with tagged disfluencies, compute disfluency scores based on the probability that the most recently spoken word is a disfluency word.

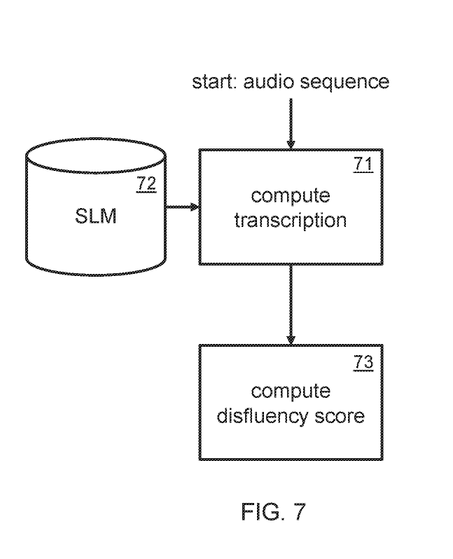

FIG. 7 shows an embodiment that uses SLM-based transcription to compute disfluency scores. A process starts with a received audio sequence. A speech recognition step 71 applies an SLM 72, wherein the SLM 72 includes n-gram models of disfluencies and non-disfluencies. The transcription step 71 produces a transcription. A step 73 uses the transcription to detect the probability that the most recent token in the transcription is a disfluency. The probability represents the disfluency score. Some embodiments include other functions, such as scaling or conditioning, between the computation of the probability of a most recent token being a disfluency and the production of the disfluency score.

### Grammar Parsing Approach

Some embodiments have a shorter timeout during periods in which at least one natural language grammar rule can parse the most recent transcriptions than during periods in which no natural language grammar rules can parse the transcription.

Some embodiments have a shorter timeout during periods in which at least one natural language grammar rule can parse the most recent transcriptions and a longer timeout for transcriptions that are complete parses but likely prefixes to other complete parses

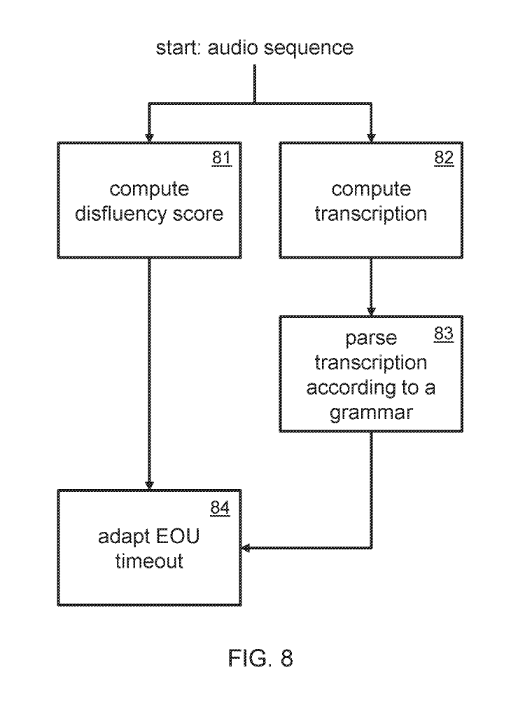

FIG. 8 shows an embodiment of a process that starts with an audio sequence. A step 81 uses the audio sequence to compute a disfluency score. A step 82 uses the audio sequence to perform speech recognition to compute a transcription. A step 83 parses the transcription according to a natural language grammar to determine whether the transcription can be parsed or not. A step 84 adapts an EOU timeout based on the disfluency score and whether the transcription can be parsed.

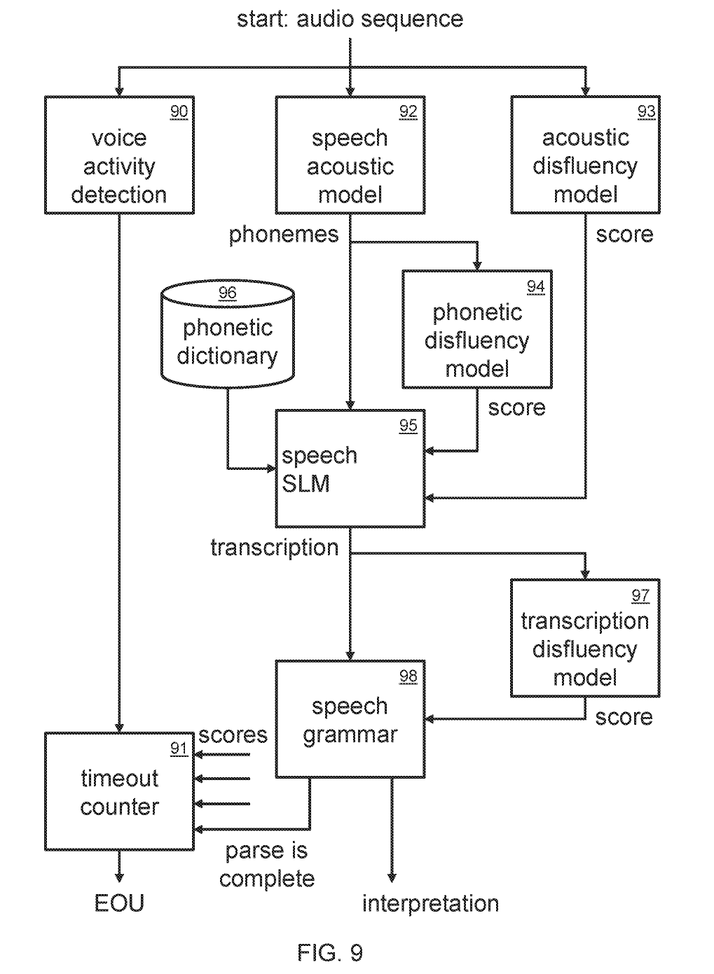

FIG. 9 shows an embodiment that combines multiple approaches to compute scores and combines those scores to adapt an EOU timeout.

A process starts with an audio sequence. A voice activity detection step 90 uses the audio sequence to determine periods of voice activity and no voice activity. A timeout counter implements an EOU timeout by counting time during periods of no voice activity, resetting the count whenever there is voice activity, and asserting an EOU condition whenever the count reaches an EOU timeout. The timeout is dynamic and continuously adapted based on a plurality of computed scores.

A speech acoustic model step 92 uses the audio sequence to compute phoneme sequences, and a parallel acoustic disfluency model step 93 computes a disfluency acoustic score. A phonetic disfluency model step 94 uses the phoneme sequence to compute a disfluency phonetic score. A speech step 95 uses a phonetic dictionary 96 on the phoneme sequence to produce a transcription. The speech SLM does so by weighting the n-gram statistics based on the disfluency acoustic score and disfluency phonetic score. A transcription disfluency model step 97 uses the transcription, tagged with disfluency n-gram probabilities, to product a disfluency transcription score. A speech grammar 98 parses the transcription to produce an interpretation. The grammar parser uses grammar rules defined to weight the parsing using the disfluency transcription score.

The timeout counter step 91 adapts the EOU timeout as a function of the disfluency acoustic score, the disfluency phonetic score, the disfluency transcription score, and whether the grammar can compute a complete parse of the transcription. Many types of functions of the scores are appropriate for computing the adaptive timeout. One function is to represent the scores as a fraction between 0 and 1; multiply them all together; divide that by two if the parse is complete; and multiply that by a maximum timeout value. Essentially any function that increases the timeout in response to an increase in any one or more scores is appropriate for an embodiment.

### Pause Phrases

Some embodiments support the detection and proper conversational handling of disfluent interruptions indicated by pause phrases. Often, in natural conversation flow, a speaker begins a sentence before having all information needed to complete the sentence. In some such cases, the speaker needed needs to use voice to gather other semantic information appropriate to complete the sentence. In such a case, the speaker pauses the conversation in the middle of the sentence, gathers the other needed semantic information, and then completes the sentence without restarting it. External semantic information can come from, for example, another person or a voice-controlled device separate from the natural language processing system.

Some examples of common English pause phrases are “hold on”, “wait a sec”, and “let me see”. Some examples of common Mandarin pause phrases are “ [symbol] [symbol] ” and “ [symbol] ”.

Some embodiments detect wake phrases, pause phrases, and re-wake phrase. Consider the example, “Hey Robot, give me directions to . . . hold on . . . Pat, what's the address? . . . <another voice> . . . Robot, 84 Columbus Avenue.” In this example, “Hey Robot” is a wake phrase, “hold on” is a pause phrase, and the following “Robot” is a re-wake phrase.

Consider the example, “ [symbol] , [symbol] . . . [symbol] . . . [symbol] , [symbol] ? <another voice> . . . [symbol] , [symbol] 2 [symbol] ”. In this example, “ [symbol] ” is a wake phrase, “ [symbol] ” is a pause phrase, and “ [symbol] ” is a re-wake phrase.

Consider the example, “ [symbol] [symbol] [symbol] [symbol] [symbol] ? . . . <another voice> . . . [symbol] 4-1 [symbol] ”. In this example, “ [symbol] ” is a wake phrase, “ [symbol] ” is a pause phrase, and “ [symbol] ” is a re-wake phrase.

In some embodiments, the re-wake phrases are different from the wake-phrases, and possibly shorter since false positives are less likely than for normal wake phrase spotting. Some embodiments use the same phrase for the re-wake phrase as for the wake phrase.

Processing incomplete sentences would either give an unsuccessful result or, if the incomplete sentence can be grammatically parsed, give and incorrect result. By having pause and re-wake phrases, embodiments can store initial incomplete sentence without attempting to process them. Such embodiments, upon receiving the re-wake phrase, detect that the additional information, when appended to the prior incomplete information, can be grammatically parsed, and completes a sentence. In such a condition, they proceed to process the complete sentence.

Some embodiments do not require a re-wake phrase. Instead, they transcribe speech continuously after the pause phrase, tokenizing it to look for sequences that fit patterns indicating semantic information that is appropriate to continue parsing the sentence. Consider the example, “Hey Robot, give me directions to . . . hold on . . . Pat, what's the address? . . . <another voice> . . . 84 Columbus Avenue.”. The words “Pat, what's the address?” are irrelevant to the meaning of the sentence.

Consider the example, “ [symbol] , [symbol] [symbol] ? <another voice> . . . [symbol] ”. “ [symbol] ?” is irrelevant to the meaning of the sentence. Consider the example, “ [symbol] [symbol] [symbol] [symbol] [symbol] ? . . . <another voice> . . . [symbol] 4-1 [symbol] ” “ [symbol] [symbol] ?” is irrelevant to the meaning of the sentence. The example has no re-wake phrase. Such embodiments detect that the partial sentence before the pause phrase is a sentence that it could complete with an address. Such embodiments parse the words following the pause phrase until identifying the words that fit the typical pattern of an address. At that time, the sentence is complete and ready for processing. Some embodiments support detecting patterns that are a number in general, a place name, the name of an element on the periodic table, or a move on a chess board.

Some such embodiments lock to the first speaker's voice and disregard others. Some such embodiments perform voice characterization, exclude voices other than the initial speaker, and conditionally consider only semantic information from a voice that reasonably matches the speaker of the first part of the sentence. Some embodiments parse any human speech and are therefore able to detect useful semantic information provided by another speaker without the first speaker completing the sentence.

### Phrase Spotting Approach

Some embodiments run a low-power phrase spotter on a client and use a server for full-vocabulary speech recognition. A phrase spotter functions as a speech recognition system that is always running and looks for a very small vocabulary of one or a small number of phrases. Only a small number of disfluencies are accurately distinguishable from general speech. Some embodiments run a phrase spotter during periods of time after a wake-up event and before an EOU event. The phrase spotter runs independently of full vocabulary speech recognition.

Many speakers use disfluencies just before or at the beginning of sentences. Some embodiments run a disfluency-sensitive phrase spotter continuously. This can be useful such as to detect pre-sentence disfluencies that signal a likely beginning of a sentence.

Some embodiments of phrase spotters detect one or several disfluency phrases. Some such embodiments use a neural network on frames of filtered speech audio.

### Training a Disfluency Model

One way to identify types of disfluencies is to label them in audio training samples. From labeled disfluencies, it is possible to build an acoustic disfluency model for non-dictionary disfluencies such as “umm” and “uh”, a disfluency SLM for dictionary word disfluencies such as “like”, or both.

Acoustic models identify phonetic features. Phonetic features can be phonemes, diphones, triphones, senones, or equivalent representations of aurally discernable audio information.

One way to train an acoustic disfluency model is to carry forward timestamps of phoneme audio segment transitions. Keep track of segments discarded by the SLM and downstream processing. Feed the audio from dropped segments into a training algorithm to train an acoustic disfluency model such as a neural network.

One way to train a phonetic disfluency model is to keep track of hypothesized recognized phonemes discarded by the SLM or downstream processing for the final transcription or final parse. Include a silence phoneme. Build an n-gram model of discarded recognized hypothesized phonemes.

Phonetic disfluency models and transcription disfluency models are two types of disfluency statistical language models.

One way to train a disfluency model is to carry forward timestamps of phoneme audio segment transitions. For each of a multiplicity of transcriptions, perform parsing multiple times, each time with a different token deletion to see if it transforms a transcription that cannot be parsed into a transcription that can be parsed or parsed with an appropriately high score. In such a case, infer that the deleted token is a disfluency. Use the discarded audio to train an acoustic disfluency model, use the token context to train a disfluency-gram SLM (an SLM that includes n-grams from a standard training corpus, plus n-grams that represent disfluencies in relation to standard n-grams), and use the dropped transcription words to train a disfluency token model.

Disfluency time ranges, phonemes, and tokens can also be labeled manually.

### Systems, CRMs, and Specific Applications

System embodiments can be devices or servers.

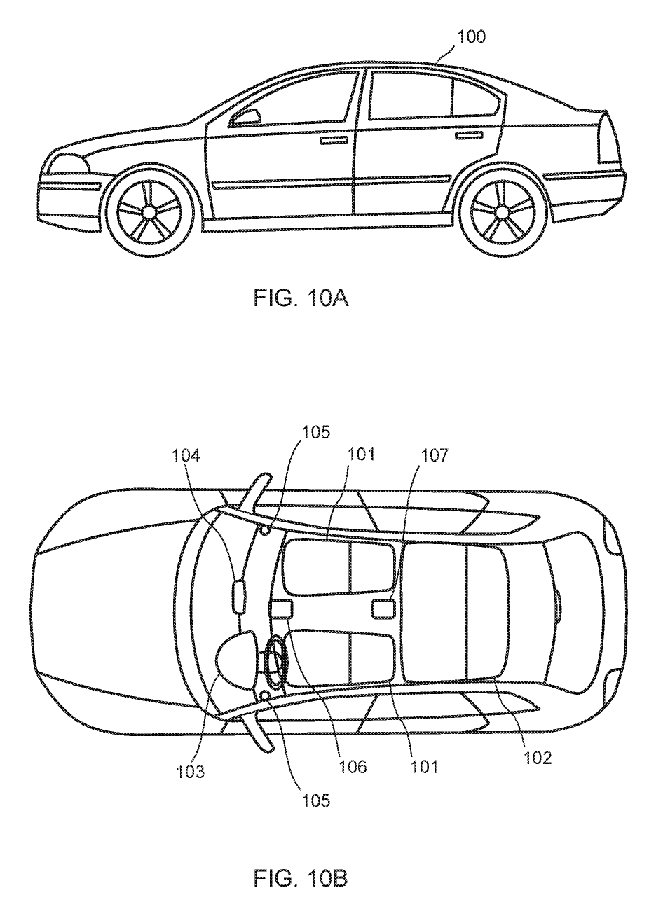

FIG. 10A shows a side view of an automobile 100. FIG. 10B shows an overhead view of automobile 100. The automobile 100 comprises front seats 101 and rear seat 102 for holding passengers in an orientation for front-mounted microphones for speech capture. The automobile 100 comprises a driver visual console 103 with safety-critical display information. The automobile 100 further comprises a general console 104 with navigation, entertainment, and climate control functions, and further comprising a local speech processing module and wireless network communication module. The automobile 100 further comprises side-mounted microphones 105, a front overhead multi-microphone speech capture unit 106, and a rear overhead multi-microphone speech capture unit 107. The side microphones and front and rear speech capture units provide for capturing speech audio, canceling noise, and identifying the location of speakers.

Some embodiments are an automobile control module, such as one to control navigation, window position, or heater functions. These can affect the safe operation of the vehicle. For example, open windows can create distracting noise, and wind that distract a driver. The safety critical nature of speech-controlled functions is also true for other human-controlled types of vehicles such as trains, airplanes, submarines, and spaceships as well as remotely-controlled drones. By accurately computing a disfluency score by or for such safety-critical embodiments, they will incur fewer parsing errors and therefore fewer operating errors.

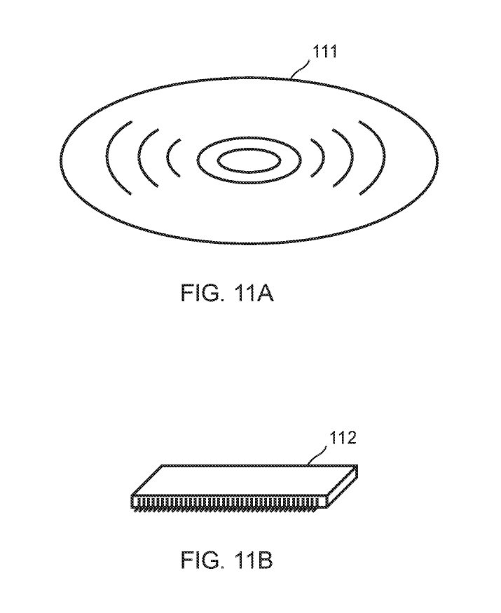

FIG. 11A shows an example non-transitory computer readable medium 111 that is a rotating magnetic disk. Data centers commonly use magnetic disks to store code and data for servers. The non-transitory computer readable medium 111 stores code that, if executed by one or more computers, would cause the computer to perform steps of methods described herein. Rotating optical disks and other mechanically moving storage media are possible.

FIG. 11B shows an example non-transitory computer readable medium 112 that is a Flash random access memory (RAM) chip. Data centers commonly use Flash memory to store code and data for servers. Mobile devices commonly use Flash memory to store code and data for system-on-chip devices. The non-transitory computer readable medium 112 stores code that, if executed by one or more computers, would cause the computer to perform steps of methods described herein. Other non-moving storage media packaged with leads or solder balls are possible.

Any type of computer-readable medium is appropriate for storing code according to various embodiments.

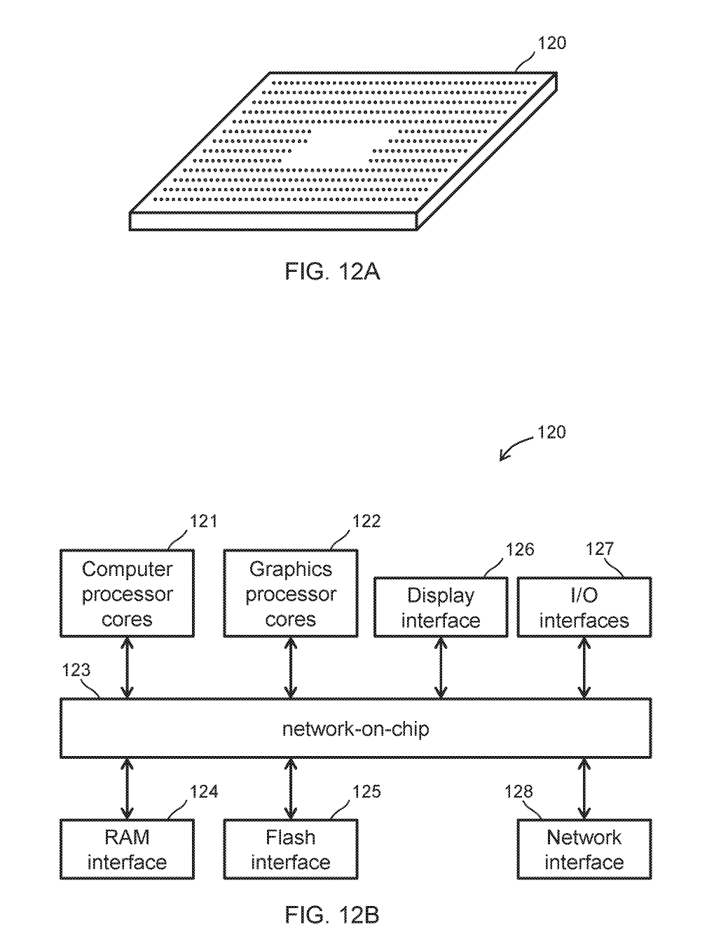

FIG. 12A shows the bottom side of a packaged system-on-chip (SoC) device 120 with a ball grid array for surface-mount soldering to a printed circuit board. Various package shapes and sizes are possible for various chip implementations. SoC devices control many embedded systems and IoT device embodiments as described herein.

FIG. 12B shows a block diagram of the system-on-chip 120. The SoC device 120 comprises a multicore cluster of computer processor (CPU) cores 121 and a multicore cluster of graphics processor (GPU) cores 122. The processors 121 and 122 connect through a network-on-chip 123 to an off-chip dynamic random access memory (DRAM) interface 124 for volatile program and data storage and a Flash interface 125 for non-volatile storage of computer program code in a Flash RAM non-transitory computer readable medium. The SoC device 120 also has a display interface 126 for displaying a GUI and an I/O interface module 127 for connecting to various I/O interface devices, as needed for different peripheral devices. The I/O interface enables sensors such as touch screen sensors, geolocation receivers, microphones, speakers, Bluetooth peripherals, and USB devices, such as keyboards and mice, among others. The SoC device 120 also comprises a network interface 128 to allow the processors 121 and 122 to access the Internet through wired or wireless connections such as Wi-Fi, 3G, 4G long-term evolution (LTE), 5G, and other wireless interface standard radios as well as ethernet connection hardware. By executing instructions stored in RAM devices through interface 124 or Flash devices through interface 125, the CPUs 121 and GPUs 122 perform steps of methods as described herein.

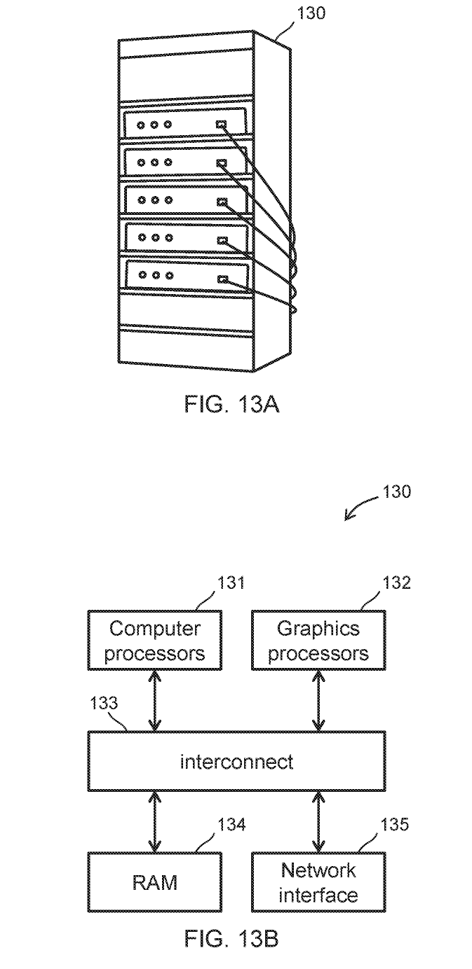

FIG. 13A shows a rack-mounted server blade multi-processor server system 130 according to some embodiments. It comprises a multiplicity of network-connected computer processors that run software in parallel.

FIG. 13B shows a block diagram of the server system 130. The server system 130 comprises a multicore cluster of computer processor (CPU) cores 131 and a multicore cluster of graphics processor (GPU) cores 132. The processors connect through a board-level interconnect 133 to random-access memory (RAM) devices 134 for program code and data storage. Server system 130 also comprises a network interface 135 to allow the processors to access the Internet. By executing instructions stored in RAM devices through interface 134, the CPUs 131 and GPUs 132 perform steps of methods as described herein.

Various embodiments are methods that use the behavior of either or a combination of humans and machines. The behavior of either or a combination of humans and machines (instructions that, when executed by one or more computers, would cause the one or more computers to perform methods according to the invention described and claimed and one or more non-transitory computer readable media arranged to store such instructions) embody methods described and claimed herein. Each of more than one non-transitory computer readable medium needed to practice the invention described and claimed herein alone embodies the invention. Method embodiments are complete wherever in the world most constituent steps occur. Some embodiments are one or more non-transitory computer readable media arranged to store such instructions for methods described herein. Whatever entity holds non-transitory computer readable media comprising most of the necessary code holds a complete embodiment. Some embodiments are physical devices such as semiconductor chips; hardware description language representations of the logical or functional behavior of such devices; and one or more non-transitory computer readable media arranged to store such hardware description language representations.

Descriptions herein reciting principles, aspects, and embodiments encompass both structural and functional equivalents thereof. Elements described herein as coupled have an effectual relationship realizable by a direct connection or indirectly with one or more other intervening elements.

Examples shown and described use certain spoken languages. Various embodiments operate, similarly, for other languages or combinations of languages. Examples shown and described use certain domains of knowledge. Various embodiments operate similarly for other domains or combinations of domains.

Some embodiments are screenless, such as an earpiece, which has no display screen. Some embodiments are stationary, such as a vending machine. Some embodiments are mobile, such as an automobile. Some embodiments are portable, such as a mobile phone. Some embodiments comprise manual interfaces such as keyboard or touch screens. Some embodiments comprise neural interfaces that use human thoughts as a form of natural language expression.

Although the invention has been shown and described with respect to a certain preferred embodiment or embodiments, it is obvious that equivalent alterations and modifications will occur to others skilled in the art upon the reading and understanding of this specification and the drawings. Practitioners skilled in the art will recognize many modifications and variations. The modifications and variations include any relevant combination of the disclosed features. In particular regard to the various functions performed by the above described components (assemblies, devices, systems, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments. In addition, while a particular feature may have been disclosed with respect to only one of several embodiments, such feature may be combined with one or more other features of the other embodiments as may be desired and advantageous for any given or particular application.

Some embodiments of physical machines described and claimed herein are programmable in numerous variables, combinations of which provide essentially an infinite variety of operating behaviors. Some embodiments herein are configured by software tools that provide numerous parameters, combinations of which provide for essentially an infinite variety of physical machine embodiments of the invention described and claimed. Methods of using such software tools to configure hardware description language representations embody the invention described and claimed. Physical machines can embody machines described and claimed herein, such as: semiconductor chips; hardware description language representations of the logical or functional behavior of machines according to the invention described and claimed; and one or more non-transitory computer readable media arranged to store such hardware description language representations.

In accordance with the teachings of the invention, a client device, a computer and a computing device are articles of manufacture. Other examples of an article of manufacture include: an electronic component residing on a motherboard, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Furthermore, all examples and conditional language recited herein are principally intended to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

The scope of the invention, therefore, is not intended to be limited to the exemplary embodiments shown and described herein. Rather, the scope and spirit of present invention is embodied by the appended claims.

What is claimed is:

1. A method of adapting an end-of-utterance timeout in a real-time speech recognition system, the method comprising:
detecting, on a real-time basis, periods of voice activity and no voice activity in a received audio sequence;
computing, on a real-time basis, a disfluency score from the audio sequence;
adapting, during receiving of the audio sequence, an end-of-utterance timeout as a function of the disfluency score to prevent an improper timeout that disrupts receiving a complete sentence in the audio sequence; and
signaling an end-of-utterance event in response to detecting a period of no voice activity exceeding the adapted end-of-utterance timeout.

2. The method of claim 1 further comprising computing, on a real-time basis, a transcription from the received audio sequence, wherein computing the disfluency score is by applying a language model to the transcription.

3. The method of claim 1 further comprising:
computing, on a real-time basis, an acoustic disfluency feature from the audio sequence; and
adapting, during receiving of audio sequence, the end-of-utterance timeout as a function of the acoustic disfluency feature.

4. The method of claim 1 further comprising:
computing, on a real-time basis, a prosodic disfluency feature from the audio sequence; and
adapting, during receiving of audio sequence, the end-of-utterance timeout as a function of the prosodic disfluency feature.

5. The method of claim 1 wherein computing the disfluency score is by use of a phrase spotter to detect a disfluency phrase.

6. A non-transitory computer-readable medium storing code that, if executed by one or more computer processors would cause the one or more computer processors to:
detect, on a real-time basis, periods of voice activity and no voice activity in a received audio sequence;
compute, on a real-time basis, a disfluency score from the audio sequence;
adapt, during receiving of the audio sequence, an end-of-utterance timeout as a function of the disfluency score to prevent an improper timeout that disrupts receiving a complete sentence in the audio sequence; and
signal an end-of-utterance event in response to detecting a period of no voice activity exceeding the adapted end-of-utterance timeout.

7. The non-transitory computer-readable medium of claim 6 that would further cause the one or more computer processors to compute, on a real-time basis, a transcription from the received audio sequence, wherein the computed disfluency score is by applying a language model to the transcription.

8. The non-transitory computer-readable medium of claim 7 wherein the language model is a classifier.

9. The non-transitory computer-readable medium of claim 7 wherein the language model is a neural network.

10. The non-transitory computer-readable medium of claim 6 that would further cause the one or more computer processors to:
compute, on a real-time basis, an acoustic disfluency feature from the audio sequence; and
adapt, during receiving of audio sequence, the end-of-utterance timeout as a function of the acoustic disfluency feature.

11. The non-transitory computer-readable medium of claim 6 that would further cause the one or more computer processors to:
compute, on a real-time basis, a prosodic disfluency feature from the audio sequence; and
adapt, during receiving of audio sequence, the end-of-utterance timeout as a function of the prosodic disfluency feature.

12. The non-transitory computer-readable medium of claim 6 wherein computing the disfluency score is by use of a phrase spotter for a disfluency phrase.

13. A method of parsing sentences with disfluent interruptions, the method comprising:
parsing a sentence from a sequence of received speech;
detecting, in the sequence of received speech, a pause phrase;
after detecting the pause phrase, parsing semantic information from the sequence of received speech to detect semantic information appropriate to continuing the parsing; and
in response to detecting the semantic information, continue parsing the the sentence.

14. The method of claim 13 wherein the received speech before the pause phrase is from a first speaker and the semantic information is from a second speaker.

15. The method of claim 13 further comprising:
performing voice characterization on the received speech; and
wherein detecting semantic information is conditional on the voice expressing the semantic information matching the voice in the received speech before the pause phrase.

16. A method of disfluency-adaptive real-time speech recognition, the method comprising:
detecting a disfluency in received audio that includes periods of speech activity and periods of no voice activity;
adapting a timeout, based on the detection of the disfluency, to prevent an improper end-of-utterance that disrupts receiving a complete sentence; and
signaling an end-of-utterance event in response to detection of no voice activity exceeding the adapted timeout.

17. The method of claim 16 wherein the step of adapting includes detecting an acoustic disfluency feature.

18. The method of claim 16 wherein the step of adapting includes detecting a prosodic disfluency feature.

19. A disfluency-adaptive real-time speech recognition system comprising:
means to detect a disfluency in received audio that includes periods of speech activity and periods of no voice activity; and
means to signal an end-of-utterance event in response to detection of no voice activity exceeding a timeout,
wherein the timeout is adapted based on the detection of a disfluency to prevent an improper end-of-utterance event that disrupts receiving a complete sentence.

20. The system of claim 19 wherein the real-time speech recognition system is an automobile control module.

21. The system of claim 19 wherein the real-time speech recognition system is safety critical and the detection of a disfluency is by computing a disfluency score and the disfluency score affects operational decision making.

22. A method of training a disfluency model, the method comprising:
performing a multiplicity of token deletion searches on transcriptions that cannot be parsed to identify a token within the transcriptions that, if deleted, turns the transcriptions that cannot be parsed into transcriptions that can be parsed; and
training a statistical language model using the deleted token based on its contexts within the multiplicity of transcriptions that cannot be parsed,
wherein the statistical language model is useful to infer disfluencies in transcriptions.
